(19) United States
(12) Patent Application Publication
(10) Pub. No.: US 2002/0091525 A1
(43) Pub. Date: Jul. 11, 2002

(54) Repeatable voice-playing gift box

(76) Inventor: Ming-Chi Hsu, Taoyuan Hsien (TW)

Correspondence Address: DOUGHERTY & TROXELL, Suite1404, 5205 Leesburg Pike, Falls Church, VA, 22041, US

(21) Appl. No.: 09/756,712

(22) Filed: Jan. 10, 2001

(51) Int. Cl. G10L 21/00

(52) U.S. Cl. 704/270

(57) ABSTRACT

A repeatable voice-playing gift box having a voice circuit therein is disclosed. This voice circuit has a recording switch and a voice playing switch. The gift presenter may press the recording switch to record the voice of blessing and present it together with the gift box to the receiver. Just by pressing the voice playing switch outside the gift box, the message recorded from the gift presenter can be heard by the receiver. By this way, the gift receiver can really feel the sincere and cordial blessing of the gift presenter.

### BACKGROUND OF THE INVENTION

1. Field of the Invention

The present invention relates to a repeatable voice-playing gift box, and more particularly to a voice circuit embedded in a gift box for recording and playing the voice repeatedly.

2. Description of the Background

Conventionally, people like to send gifts in some festivals, or in visiting a friend as a courtesy behavior. However, in practice, the gift receiver seldom opens the gift box in front of the visitor. Most of the receivers do not open their gift boxes until the visitor leaves away. Therefore, the gift box has no function of promoting the affection further. Furthermore, when two friends are far from one another and cannot meet face to face, although one of them remembers to mail, send in person or entrust someone to send a gift box to his/her friend. Generally, some quite intimate blessing or words is appended in the gift, often these blessing or words is inconvenient to be spoken out in front of the gift receiver. Maybe, the message or words are spoken by someone else on behalf of the gift presenter, whereas in general, what the presenter desired to be presented can not be full stated.

Nowadays, the existing gift box can only express a respect by the material itself but cannot completely transmit the feeling of the gift presenter. Besides, in general, many people are too conservative and timid to express their feelings in front of other people. In view of these, the creator studies the invention of this repeatable voice-playing gift box. It mainly presents together with the gift box the words that the gift presenter cannot speak out face to face. Even though the words cannot be expressed in person, the gift receiver can just play the recorded voice and understand the love and respect from the gift presenter.

### SUMMARY OF THE INVENTION

Accordingly, the primary object of the present invention is to provide a repeatable voice-playing gift box having a voice circuit. The voice circuit has a recording switch and a voice playing switch. The gift presenter may press the recording switch to record voices of blessings. The gift presenter can record and play his/her message repeatedly until a satisfactory voice message is recorded. Only by pressing the voice playing switch outside the gift box, the gift receiver may hear the message recorded by the gift presenter. By this way, the gift receiver really senses the real meaning from the gift presenter.

### BRIEF DESCRIPTION OF THE DRAWINGS

FIG. 1 illustrates the outlook of gift box.

FIG. 2 shows the voice circuit diagram of an embodiment of the present invention.

### DETAILED DESCRIPTION OF THE INVENTION

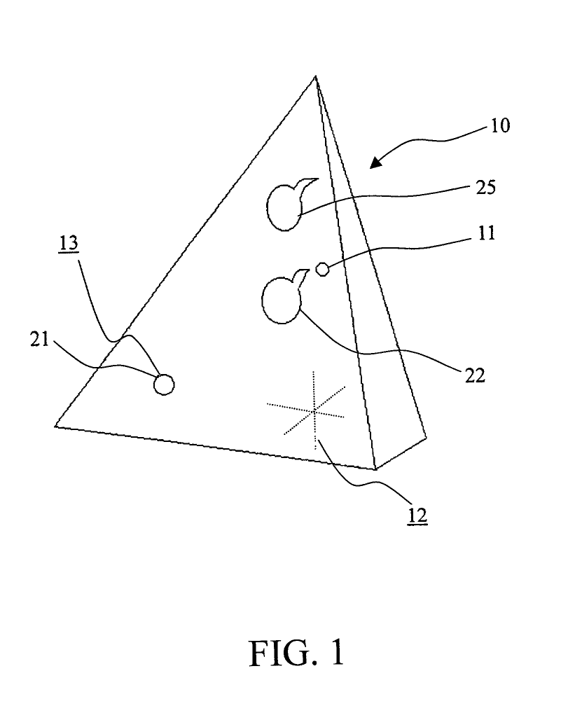

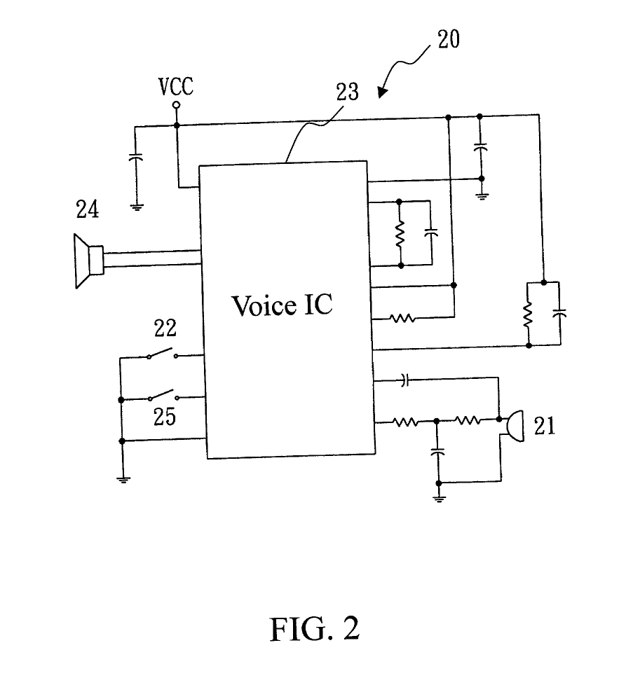

FIG. 1 illustrates the outlook of gift box, in which a voice circuit 20 is installed on an appropriate position in the inner side of the gift box 10. The voice circuit 20 shown in FIG. 2 contains a microphone 21 controlled by recording switch 22 for recording the voice from the user; a voice IC 23 containing a memory (not shown) and serving to convert the voice message transmitted by microphone 21 into digital signals and saves the signals in the memory; and a speaker 24 controlled by voice playing switch 25 that plays the voice recorded by the user.

A plurality of holes 11 are formed on the voice playing and recording switches 25 and 22 of the gift box, respectively. After the voice circuit 20 is installed therein, the voice playing switch 25 is located outside the hole 11, whereas the recording switch 22 is hidden in holes 11. Besides, several speak holes 12 are installed at the respective speakers 24 of the gift box 10. Then, the voice can be transmitted out of the gift box 10 and is heard clearly. A microphone hole 13 is formed on the microphone 21, which will cause the voice absorbing portion of the microphone 21 exposed outside so that the voice can be completely absorbed.

After a user has purchased the gift box 10, he/she can use a sharp object (such as a screwdriver, an awl, etc.) to insert into the hole 11 so as to press the recording switch 22 inwards. In the process of recording, the user has to keep pressing the recording switch 22 continuously until the spoken words are completely recorded, or do not release until the longest time of recording is elapsed. During this time period the voice message is already stored in memory. Then, the user can press the voice playing switch 25 to check the effect of voice recorded. If there is too much noise in the message, or the user does not satisfy the contents of voice message, the user is only required to press recording switch 22 to record another new message again. The new voice signals received by voice IC 23 will cover the contents stored in the memory earlier. In other words, as the recording is completed, the user needs not to press the recording switch 22 anymore. Voice IC 23 can store the contents of voice message in memory.

Whenever a user wants to send, mail or entrust someone to send in person the gift box 10 to a gift receiver, even if the user cannot express some words that he/she wants to speak out, or the user cannot go over to the gift receiver in person, the gift receiver just needs to press the voice playing switch 25 exposed outside gift box 10, the contents recorded earlier will immediately played at speaker 24. It seems that the user is speaking out those words in person. The situation contrived is just like both the gift presenter and the gift box are in front of the gift receiver, who will especially feel the warm love of the user.

Above all, the repeatable voice-playing gift box of the present invention enables the user's blessing to be sent out together with the gift box. It can contrive a situation which is just like both the gift presenter and the gift box are in front of the gift receiver. Nevertheless, the techniques and drawings abovementioned are merely a preferred embodiments of the invention. Whenever any variation or modifications about the functions of the present invention can be performed by those skilled in the art without departing from the scope and spirit of the present invention appended in the following

We claim:

1. A repeatable voice-playing gift box having a voice circuit therein, and said voice circuit comprising:
a microphone controlled by a recording switch;
a voice IC including a memory for converting voice signals to digital signals and storing the converted digital signals in said memory; and
a speaker controlled by a voice playing switch,
characterized in that said recording switch is pressed to store the voice signal in the voice IC, so that as the voice playing switch is pressed, a user will hear the pre-stored voice emitting from the gift box.

2. The repeatable voice-playing gift box as recited in claim 1, wherein the recording switch is pressed to start recording again, and the stored voice message earlier is covered and thus, eliminated.

3. The repeatable voice-playing gift box as recited in claim 1, wherein several speaker holes are formed on said gift box at positions with respect to said speaker, thereby, voice clearly spreads out far away from said gift box.

4. The repeatable voice-playing gift box as recited in claim 1, wherein a microphone hole is formed on said gift box at position with respect to the microphone so as to make the voice absorbing part of said microphone exposed out of said gift box to facilitate absorbing of voice.
